(19) United States
(12) Patent Application Publication
(10) Pub. No.: US 2009/0315327 A1
(43) Pub. Date: Dec. 24, 2009

(54) Anti-rotation locking device for tube unions

(76) Inventor: Christopher David Plucker, Lynchburg, VA (US)

Correspondence Address: VYTAS R. MATAS, 2412 CEDARWOOD RD., PEPPER PIKE, OH, 44124, US

(21) Appl. No.: 12/214,815

(22) Filed: Jun. 23, 2008

(51) Int. Cl. F16L 25/00

(52) U.S. Cl. 285/330

(57) ABSTRACT

An anti-rotational assembly for a union fitting is disclosed having a hexagonal cental portion non movably covering the hexagonal cental portion of a union fitting and having deformable tubular sections sections covering the nuts of the union fitting and which are crimped onto properly compressed nuts on the union fitting to prevent any further rotation of the nuts.

### BACKGROUND OF THE INVENTION

1. Field of the Invention

The present invention is generally drawn to tube or pipe unions such as those provided by the SWAGELOK COMPANY and more particularly to such unions fitted with an anti-rotation device.

2. Description of the Prior Art

Unions or fittings for connecting two tubes or pipes are generally known and have two open barrel sections with external threads extending from an elevated central hexagonal section. In use, pipes are fitted with a nut and ferrule and inserted into the open barrel sections of the fitting. The nuts are then tightened by screwing them onto the threaded external sections of the fitting while holding the fitting's central hex section with a wrench.

The Swagelok Company is a leading manufacturer of such fittings and their use is specifically detailed in Swagelok Document #ms12-01. To ensure the proper installation of Swagelok fittings the Swagelok Company recommends that the fittings are tightened by turning the nut ½ turns from finger tight and that the fitting then be gauged for proper continued tightening.

On initial installation, an inspection gauge assures the installer or inspector that a fitting has been sufficiently tightened. The gauge is a preset wedge that is used as follows:

the gauge is positioned next to the gap between the nut and central hex body;

If the gauge will not enter the gap the fitting is sufficiently tightened;

If the gauge will enter the gap, additional tightening is required until the gauge does not fit.

The above described Swagelok Company unions are used for various applications including their use for core exit thermocouple conduits on the upper internals of Pressurized Water Reactors (PWR). However, these nuclear reactor installations require that the fittings be adapted to prevent rotation which could loosen the connections and have their parts fall into the reactor. The current thermocouple and instrumentation column conduit Swagelok Company fittings are locked by a simple welded on tab, which locks the union body to the fitting's nuts. This tab prevents rotation very effectively.

Although the weld tab locks the fitting from loosening it has several drawbacks. Being a welded part it cannot be installed underwater, which is a vital trait in nuclear applications. Also, welded installations tend to be vulnerable to weld quality and installer skill.

### SUMMARY OF THE INVENTION

The present invention solves the above mentioned problems of prior art anti-rotation installations and others by providing a locking device which is installed onto a tube union and is fully captured prior to crimping it to produce anti-rotation. An external/internal locking hexnut feature allows the union to be tightened and swaged in a normal manner and gauging windows and a specially designed gauge allows the installation of the union to be gauged to insure proper swage and tightening of the union. The locking crimp is preformed with a simple keyed crimp tool which allows underwater installation and requires little skill from the installer. The use of a hydraulic crimp tool was found to be quite effective.

From the foregoing it will be seen that one aspect of the present invention is to provide a device adaptable to a Swagelok Company union making it anti-rotational.

Another aspect is to allow gauging of the union with the anti-rotational device installed.

Yet another aspect is to provide an anti-rotational device for a union which may be installed easily in an underwater environment.

These and other aspects of the present invention will be obvious to those of ordinary skill in this area upon a perusal of the following description of the preferred embodiment when considered with the accompanying drawings.

### BRIEF DESCRIPTION OF THE DRAWINGS

In the drawings wherein;

FIG. 1 is perspective view of the anti-rotational union device of the present invention;

FIG. 2 is a front view of the device of FIG. 1 showing cross-section A-A;

FIG. 3 is a sectional view of FIG. 2 along section A-A;

FIG. 4 is a flow diagram of the installation of the FIG. 1 device on a Swagelok fitting with drawing depictions on the left side of each step;

FIG. 5 is a perspective view of the tightening gauge used in step 4 of FIG. 4;

FIG. 6 is perspective view of the gauge of FIG. 5 used in the device of the present invention;

FIG. 7 is a depiction of the gauge of FIG. 5 displaying a fully tightened position of the Swagelok fitting; and

FIG. 8 is a depiction of the gauge of FIG. 5 displaying an untightened position of the Swagelok fitting.

### DESCRIPTION OF THE PREFERRED EMBODIMENT

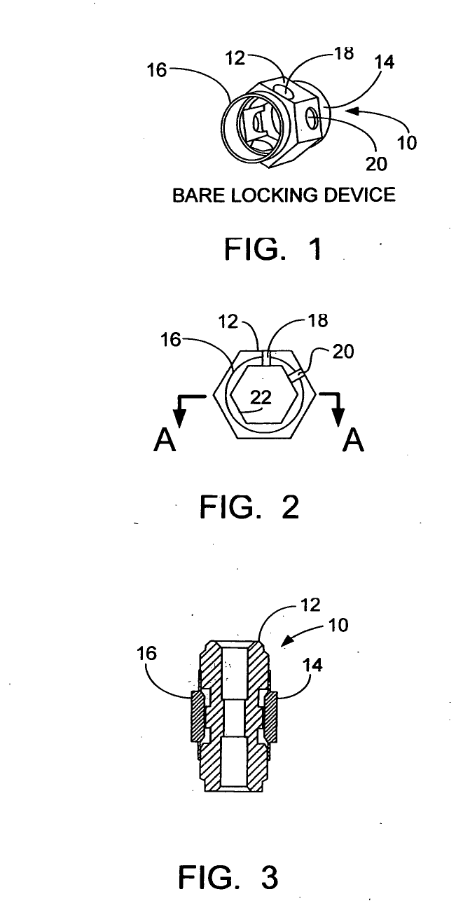

Referring now to the drawings generally and to FIGS. 1-3 in particular, an anti-rotational assembly (10) has a central portion (12) with a pair of tubular sections (14, 16) extending there from. The central portion (12) is formed as a hexagon with two openings (18, 20) extending into the assembly (10). The internal portions (22) of central portion (12) are also formed as a hexagon and are made to fit a central hexagonal portion (28) of a Swagelok Company union therein with space at each side of the central portion (12) for partially covering the union's compression nuts (38, 40).

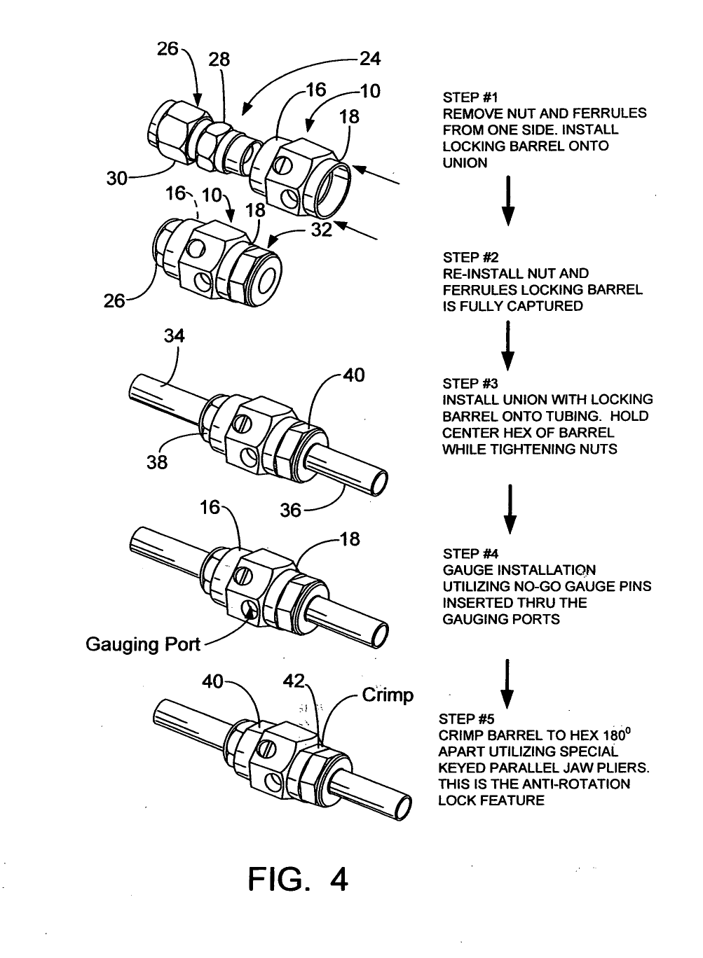

Turning next to FIG. 4, one Swagelok Company union assembly (24) is shown with a nut and ferrule assembly (26) on one side which is installed into the anti-rotation assembly (10) with the central hex portion (28) interference fitting into the internal hex portion (22) of the assembly (10) along with a part of a threaded portion (30) between the assembly (26) and the central portion (28). A second nut and ferrule assembly (32) is installed on the Swagelok assembly (24) to capture the anti-rotation assembly (10) to the assembly (24). Tubing (34, 36) is now installed into the modified Swagelok assembly (24) and the nuts (38, 40) of the assemblies (26, 32) are now hand tightened 1½ turns as per Swagelok Company requirements. Since the gauged spaces between the central portion (28) and threads (30) and the other side are now covered by tubular portions (16,18) of the assembly (10) a new gauging system is required which will be disclosed later. In any event fitting (24) will be properly compressed according to Swagelok Company instructions. Next the tubular portions (16, 18) are crimped using known parallel jaw crimping pliers (not shown) to leave flat portions (40, 42) on both the top and bottom of the tubes which conform to some of the faces of the hexagonal nuts (26, 32). This prevents the nuts (26, 32) from being rotated to better tighten or loosen them from the preset position.

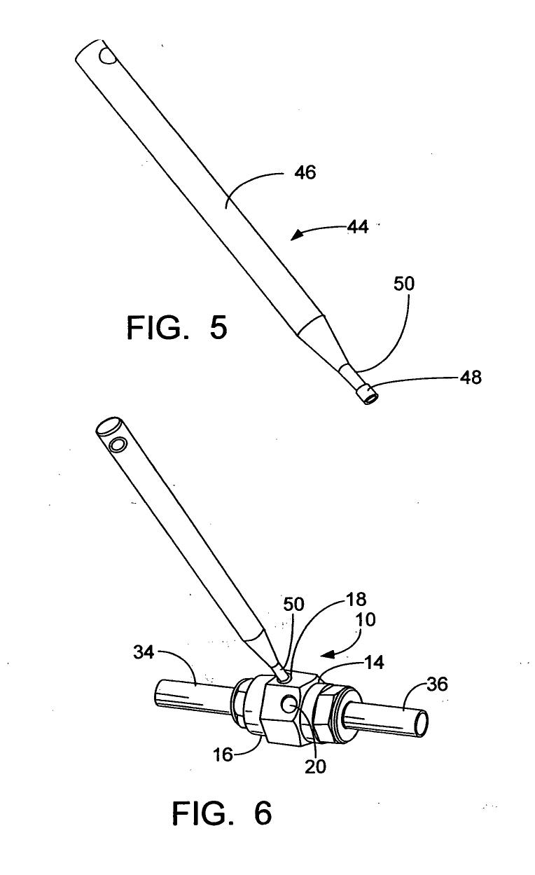

Turning now to FIGS. 5-8, it is seen that since the anti-rotation assembly (10) fully encloses the fitting a new approach to gaugeing was required.

First to allow gauging, the ports or openings (18, 20) allow access to the gap in the fitting between the nuts (28, 40) and the central hex portion (28) where the Swagelok Company gap gauge is typically inserted.

To replace the function of this gap tool, but yet still fit into the gauging port holes (18, 20) a pin gauge assembly (44) was designed. The assembly (44) has a tubular body (46) with an end tip (48). The diameter of the tip (48) is the same as the thickness of the Swagelok Company gap tool. So the pin gage (44) can replicate the function of the gap tool by insertion thru the ports (18, 20) of an installed fixture having the anti-rotating assembly (10) located thereon.

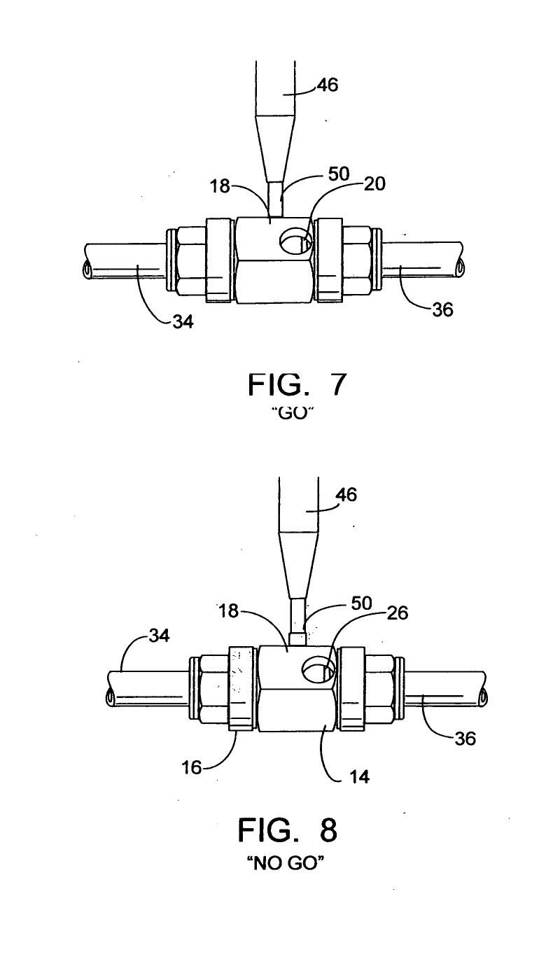

To allow the use the pin gauge (44) it will be noted that the central portion (12) of the anti rotatin assembly (10) is wider than the central portion (26) of the fitting and thus aligns the end located gauge ports (18, 20) with the gap between the nuts (38, 40) and the hex (28) of the fitting. The pin gauge (44) is thus inserted thru the gauge port and into the gap between the nut and the central hex. If the tip (48) fits into the gap the fitting is insufficiently tightened, and needs additional tightening “GO” tighten display as seen in FIG. 7.

If the tip (48) does not fit the fiing is sufficiently tightened “NO” more tightening display as seen in FIG. 8.

In addition to the operator “feel” of the pin gauge (44) fitting or not fitting into the gap, there are additional visual references built into the pin gauge to help the operator determine if the pin gauge is a “GO” or “NO GO”. Notice there is narrow section (50) on the pin gauge (44) at a specified height. This section (50) is painted a bright yellow color, and the tip (48) is left the silver color of the stainless steel metal used to manufacture the gauge. In use if the pin gauge drops into the gap, no silver tip will be visible see FIG. 7. But if the gauge is “NO GO” the silver tip will be visible as seen in FIG. 8.

From the foregoing it will be seen that the present invention has at least four basic advantages over the welded locking tab presently used for nuclear installations.
1. The fully captured nature of the device is a key advantage especially in its primary intended purpose in the nuclear industry. Even if the device in improperly installed (not crimped) of fails in its primary locking function, it will not become a loose part and damage the reactor.
2. The internal/external mating hex feature allow the union to be installed as if the locking device was not there and allows the device to be pre-installed on the union.
3. The gauging ports allow the union to be inspected for proper installation and swaging with the locking device pre installed.
4. The locking/crimping operation is fast, simple and can be performed by an unskilled operator.

It will be understood that certain details and modifications have been deleted herein for the sake of conciseness and readability but they are fully intended to be within the scope of the following claims as obvious to those of ordnary skll in this art area.

I claim:

1. An anti-rotation union fitting for coupling together two tubular pipe sections comprising;
a first central section having individual faces for gripping with a tool and having a passage there through;
a first and second tubular section extending from the ends of said central section and having a threaded external portions for threading a nut thereon to retain tubes when inserted therein; and
an anti-rotation assembly means non rotationally mounted on said central section for preventing rotation of nuts properly threaded onto said first and second tubular sections.

2. An anti-rotation union fitting as set forth in claim 1 wherein said anti rotation assembly comprises a second central section fitting over the faces of said first central sections and part of said tubular sections to partially cover nuts threaded on said first and second tubular sections and said second central section having a deformable tubular section extending from each end thereof with crimped sections covering a part of said nuts.

3. An anti-rotation union fitting as set forth in claim 2 wherein said second central section has a pair of openings leading to a threaded portion of said first and second tubular sections for gauging the proper compression of nuts thereon.

4. An anti-rotation union fitting as set forth in claim 3 including a tubular gauge having a tip thereon for indicating proper spacing between the nut and said central section when inserted into one of said pair of openinngs.

5. An anti-rotation union fitting as set forth in claim 4 wherein said gauge has a tubular colored portion next to said tip for indicating improper spacing.

6. An anti-rotation assembly for a union fitting having a central hex area and threaded tubular sections extending there from for retaining tubes therein with hexagonal compression nuts threaded thereon comprising;
a hexagonal central section fitting over the central hex section of the fitting and on a part of the nuts threaded on the tubular sections of the fitting; and
deformable tubular sections extending from said hexagonal central section to cover at least a part of the nuts.

7. An anti-rotation union fitting as set forth in claim 6 wherein said deformable tubular section has a crimped area covering at least one face of said hexagonal nut.

8. An anti-rotation union fitting as set forth in claim 7 wherein said hexagonal central section has an opening there through leading to the threaded portion of the fitting for gauging proper nut compression.

9. An anti-rotation union fitting as set forth in claim 7 wherein said hexagonal central section has a pair of openings one at each end thereof to gauge the proper compression of nuts on each end of the fitting.

10. An anti-rotation union fitting as set forth in claim 8 including a tip gauge extendable through said opening to gauge the spacing between the central portion of the fitting and a nut on the threaded sections of the fitting.

11. An anti-rotation union fitting as set forth in claim 10 wherein said tip gauge has an end portion and a narrower tubular portion extending there from indicating improper nut compression when only the narrower portion is seen above said opening in said hexagonal central section.

12. An anti-rotation union fitting as set forth in claim 11 wherein proper nut compression is indicated when said end portion of said tip gauge is seen above said opening in said hexagonal central section.
